(19) United States
(12) Patent Application Publication
(10) Pub. No.: US 2014/0285837 A1
(43) Pub. Date: Sep. 25, 2014

(54) Printer Pooling Mechanism

(71) Applicants: Joseph Gaertner, Lafayette, CO (US); Marquis Waller, Beverly, OH (US); Janeen E. Jahn, Lafayette, CO (US); Mihai Ciocarlie, Timisoara (RO)

(72) Inventors: Joseph Gaertner, Lafayette, CO (US); Marquis Waller, Beverly, OH (US); Janeen E. Jahn, Lafayette, CO (US); Mihai Ciocarlie, Timisoara (RO)

(21) Appl. No.: 13/847,602

(22) Filed: Mar. 20, 2013

(51) Int. Cl. G06F 3/12

(52) U.S. Cl. CPC G06F 3/1296
USPC 358/1.15

(57) ABSTRACT

A method disclosed. The method includes generating a printer pool object that represents a pool including one or more printers.

### FIELD OF THE INVENTION

The invention relates to the field of print systems, and in particular, to managing print flow.

### BACKGROUND

Printers are common peripheral devices attached to computers. A printer allows a computer user to make a hard copy of documents that are created in a variety of applications and programs on a computer. To function properly, a channel of communication is established (e.g., via a network connection) between the printer and the computer to enable the printer to receive commands and information from the host computer.

Once a connection is established between a workstation and the printer, printing software is implemented at a print server to manage a print job from job entry and management through the complete printing process. On occasion an operator (or user) may wish to direct a job to multiple printers. To do this in conventional systems, multiple printers must be created post-spool in the printing software that use the same job selection criteria. Another mechanism is to create pre-spool a virtual print or logical destination that specifies a list of possible printers. Yet another mechanism is to specify a list of possible printers pre-spool. However, each of the above-described mechanism are in efficient.

Accordingly, an efficient printer pooling mechanism is desired.

### SUMMARY

In one embodiment, a method includes generating a printer pool object that represents a pool including one or more printers.

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIG. 2 is a flow diagram illustrating one embodiment of a process for generating a printer pool object;

FIGS. 3A and 3B illustrate screen shots of embodiments of a printer pooling graphical user interface; and

FIG. 4 illustrates one embodiment of a computer system.

### DETAILED DESCRIPTION

A printer pooling mechanism is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

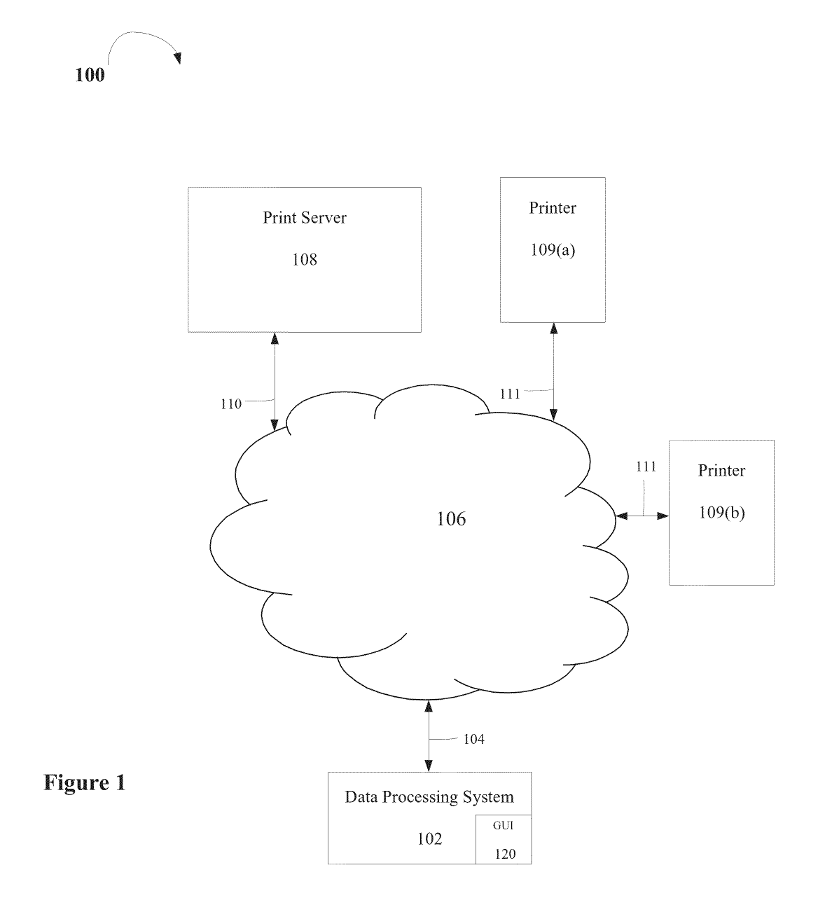

FIG. 1 illustrates one embodiment of a data processing system network 100. Network 100 includes a data processing system 102, which may be either a desktop or a mobile data processing system, coupled via communications link 104 to network 106. In one embodiment, data processing system 102 is a conventional data processing system including a processor, local memory, nonvolatile storage, and input/output devices such as a keyboard, mouse, trackball, and the like, all in accordance with the known art. In one embodiment, data processing system 102 includes and employs the Windows operating system or a similar operating system and/or network drivers permitting data processing system 102 to communicate with network 106 for the purposes of employing resources within network 106.

Network 106 may be a local area network (LAN) or any other network over which print requests may be submitted to a remote printer or print server. Communications link 104 may be in the form of a network adapter, docking station, or the like, and supports communications between data processing system 102 and network 106 employing a network communications protocol such as Ethernet, the AS/400 Network, or the like.

According to one embodiment, network 106 includes a print server 108 that serves print requests over network 106 received via communications link 110 between print server 108 and network 106. Print server 108 subsequently transmits the print requests via communications link 110 to one of printers 109 for printing, which are coupled to network 106 via communications links 111.

Although described as separate entities, other embodiments may include print server 108 being incorporated in one or more of the printers 109. However in other embodiments, the print server and printer may be physically separate entities. Therefore, the data processing system network depicted in FIG. 1 is selected for the purposes of explaining and illustrating the present invention and is not intended to imply architectural limitations. Those skilled in the art will recognize that various additional components may be utilized in conjunction with the present invention.

According to one embodiment, print server 108 implements a printing software product that manages the printing of documents from data processing system 102 between data processing system 102 and one or more of printers 109. In other embodiments, the printing software manages printing of documents from multiple data processing systems 102 to the one or more printers 109.

According to one embodiment, the printing software product may be implemented using either InfoPrint Manager (IPM) or InfoPrint ProcessDirector (IPPD), although other types of printing software may be used instead. In a further embodiment, data processing system 102 includes a print application that interacts with the printing software product at printer server 108 to provide for efficient transmission of print jobs.

In one embodiment, the printing software product includes a graphical user interface (GUI) 120 that enables a system administrator (or operator) to interact with the print application. In a further embodiment, an operator at data processing system 102 implements GUI 120 to automatically submit print jobs to the printing software product at printer server 108.

As discussed above, a user may wish to direct print jobs to multiple printers. According to one embodiment, a printer pool object may be created using GUI 120 that represents multitude (or pool) of printers. In such an embodiment, a printer pool includes an attribute having a list of printers in the pool, and an attribute having a representative printer for reporting capabilities to clients.

In a further embodiment, a printer pool object is a post spool object in print server 108 that points to 0-n printer objects. The printer pool object presents a single object to a user to which a print job may be forwarded. Accordingly, printer pool objects behave like printers except that jobs forwarded to a printer pool object may print on any of the printers defined in the printer pool object.

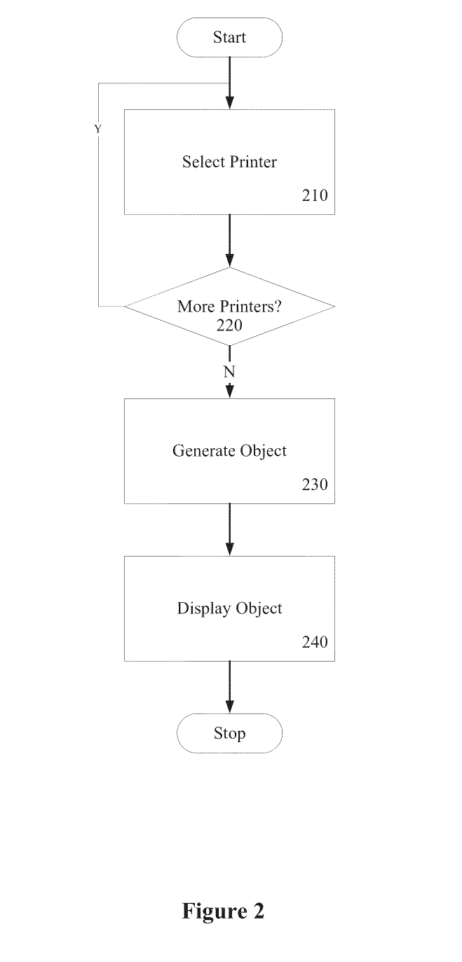

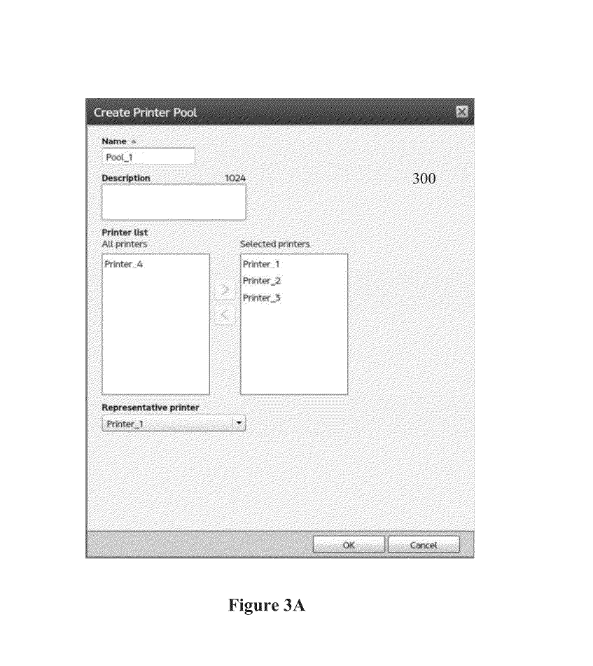

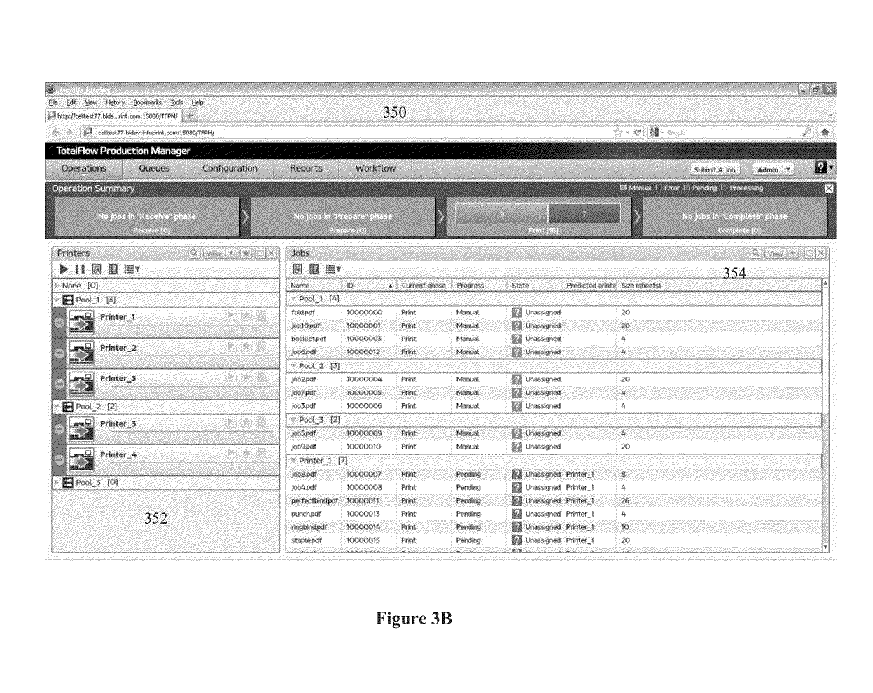

FIG. 2 is a flow diagram illustrating one embodiment of a process for generating a printer pool object. At processing block 210, a printer is selected, from among a list of available printers, to be included in the pool. In one embodiment, the pool may be named (or re-named) anytime before, during or after the process. FIG. 3A illustrates one embodiment of a screen shot of a create printer pool window 300 of GUI 120.

At processing block 220, a determination is made as to whether an additional printer is to be included in the pool. If so, control is returned to processing block 210 where another printer is selected. However if no additional printers are to be included, the printer pool object is generated, processing block 230. As shown in FIG. 3A, window 300 features the generation of a Pool_1, which features selected printers Printer_1, Printer_2 and Printer_3 from among a list of all printers. Window 300 also includes an option that enables a user to select a representative printer from among the selected printer to correspond with the representative printer attribute.

Referring back to FIG. 2, the printer pool object may be displayed in GUI 120 upon generation, processing block 240. Once displayed, the printer pool object may be selected by a user as part of a print workflow. Thus as discussed above, the printer pool object may be selected as a destination printer to which print jobs are forwarded. While processing the workflow, print jobs are forwarded to each of the printers included in the pool.

FIG. 3B illustrates one embodiment of a screen shot of an operation window 350 of GUI 120. As shown in FIG. 3B, Window 350 includes a sub-window 352 that includes a list of printers handling print jobs, with printer pool objects (e.g., Pool_1) being included in the list along with the associated printers. Window 350 includes a sub-window 354 that lists print jobs currently being printed to the printer pool objects.

The above-described printer pool object provides a simple way to manage printers assigned to a pool, a visual representation of a group of printers and a visual representation of jobs assigned to the pool.

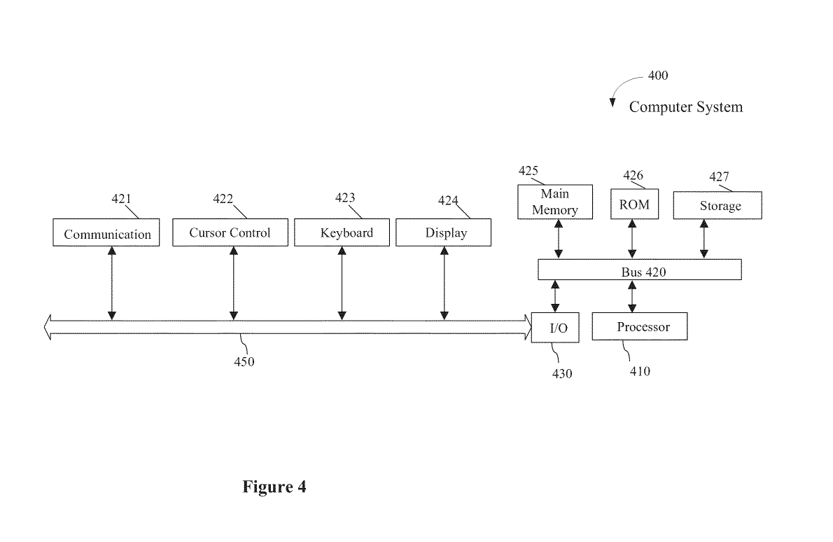

FIG. 4 illustrates a computer system 400 on which data processing system 102 and/or server 108 may be implemented. Computer system 400 includes a system bus 420 for communicating information, and a processor 410 coupled to bus 420 for processing information.

Computer system 400 further comprises a random access memory (RAM) or other dynamic storage device 425 (referred to herein as main memory), coupled to bus 420 for storing information and instructions to be executed by processor 410. Main memory 425 also may be used for storing temporary variables or other intermediate information during execution of instructions by processor 410. Computer system 400 also may include a read only memory (ROM) and or other static storage device 426 coupled to bus 420 for storing static information and instructions used by processor 410.

A data storage device 425 such as a magnetic disk or optical disc and its corresponding drive may also be coupled to computer system 400 for storing information and instructions. Computer system 400 can also be coupled to a second I/O bus 450 via an I/O interface 430. A plurality of I/O devices may be coupled to I/O bus 450, including a display device 424, an input device (e.g., an alphanumeric input device 423 and or a cursor control device 422). The communication device 421 is for accessing other computers (servers or clients). The communication device 421 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

1. A method comprising generating a printer pool object that represents a pool including one or more printers, wherein the printer pool object is a post spool object that presents a single object to be selected as a destination printer to which a print job is to be forwarded.

2. (canceled)

3. The method of claim 1 further comprising:
receiving a print job indicating the printer pool object as a destination printer; and forwarding the print job to the one or more printers included in the pool.

4. The method of claim 1 wherein generating the printer pool object further comprises selecting a first printer to be included in the pool.

5. The method of claim 4 further comprising:
selecting a second printer to be included in the pool; and
generating the printer pool object representing a pool including the first and second printers.

6. The method of claim 5 further comprising displaying the printer pool object.

7. A print server comprising a printing software product to generate a printer pool object that represents a pool including one or more printers, wherein the printer pool object is a post spool object that presents a single object to be selected as a destination printer to which a print job is to be forwarded.

8. (canceled)

9. The print server of claim 7 wherein the printer pool includes an attribute having a list of printers in the pool and an attribute having a representative printer for reporting capabilities to clients.

10. The print server of claim 7 further wherein the printing software product further receives a print job indicating the printer pool object as a destination printer and forwards the print job to the one or more printers included in the pool.

11. The print server of claim 7 wherein generating the printer pool object further comprises selecting a first printer to be included in the pool.

12. The print server of claim 11 wherein generating the printer pool object further comprises selecting a second printer to be included in the pool and generating the printer pool object representing a pool including the first and second printers.

13. The print server of claim 12 wherein the printing software product further displays the printer pool object.

14. An article of manufacture comprising a non-transitory computer-readable medium including instructions, which when executed by a processor, performs a process comprising generating a printer pool object that represents a pool including one or more printers, wherein the printer pool object is a post spool object that presents a single object to be selected as a destination printer to which a print job is to be forwarded.

15. (canceled)

16. The article of manufacture of claim 14 wherein the printer pool includes an attribute having a list of printers in the pool and an attribute having a representative printer for reporting capabilities to clients.

17. The article of manufacture of claim 14 comprising a computer-readable medium including instructions, which when executed by a processor, further performs a process comprising:
receiving a print job indicating the printer pool object as a destination printer; and
forwarding the print job to the one or more printers included in the pool.

18. The article of manufacture of claim 14 wherein generating the printer pool object further comprises selecting a first printer to be included in the pool.

19. The article of manufacture of claim 18 comprising a computer-readable medium including instructions, which when executed by a processor, further performs a process comprising:
selecting a second printer to be included in the pool; and
generating the printer pool object representing a pool including the first and second printers.

20. The article of manufacture of claim 19 comprising a computer-readable medium including instructions, which when executed by a processor, further performs a process comprising displaying the printer pool object.
